(19) United States
(12) Patent Application Publication
(10) Pub. No.: US 2009/0029646 A1
(43) Pub. Date: Jan. 29, 2009

(54) Communications device, a system and method using inductive communication

(75) Inventors: Niels Kristian Kristiansen, Smorum (DK); Jacob Schultz, Smorum (DK)

Correspondence Address: BIRCH STEWART KOLASCH & BIRCH, PO BOX 747, FALLS CHURCH, VA, 22040-0747, US

(73) Assignee: OTICON A/S, Smorum (DK)

(21) Appl. No.: 12/219,146

(22) Filed: Jul. 16, 2008

(30) Foreign Application Priority Data
Jul. 26, 2007 (EP) 07113161.9

(51) Int. Cl. H04B 7/00

(52) U.S. Cl. 455/41.2

(57) ABSTRACT

The invention relates to the transmission of a signal from a communications device to another device (e.g. a hearing aid) by inductive communication and particularly to a scheme for improving the signal quality at the location of the other device. The object of the present invention is to provide an alternative scheme for improving the quality of inductive communication between two (e.g. portable) devices. The basic idea is to arrange at least two induction coils at an angle to each other in a transmitting device and to apply electrical signals comprising carrier signals comprising a carrier frequency f_{c} to the at least two induction coils, the carrier signals of the two electrical signals being phase shifted relative to each other. An advantage thereof is that a reduced drop out is achieved. The invention may e.g. be used for portable communications devices requiring communication with another device over a relatively short distance, e.g. a body-worn audio selection device communicating with a head-worn audio listening device, e.g. a head set or a hearing aid.

### TECHNICAL FIELD

This invention relates to inductive communication between two devices over a relatively short distance, such as below 3 m. The invention relates particularly to the transmission of a signal from a communications device to another device by inductive communication and particularly to a scheme for improving the signal quality at a location of the other device. The invention relates specifically to a communications device and to a system comprising a communications device and another device, the devices being adapted to inductively communicate with each other.

The invention may e.g. be useful in applications such as portable communications devices requiring communication with another device over a relatively short distance, e.g. a body-worn audio selection device communicating with a head-worn audio listening device, e.g. a head set or a hearing aid. The invention is particularly useful for applications where a continuous signal is required or preferred, e.g. in case of an audio transmission device wirelessly transmitting a continuous (e.g. digital, e.g. encoded) audio signal (streaming audio) to a receiving audio device, such as a listening device.

### BACKGROUND ART

The following account of the prior art relates to one of the areas of application of the present invention, wireless communication of audio signals to a head worn audio device, e.g. a hearing aid, cf. e.g. EP 1 460 769 A1.

In a system comprising a hearing aid and an audio selection device for selecting one audio signal among a multitude of audio signals and forwarding the selected one to the hearing aid by means of inductive communication, wherein the audio selection device has one transmitter coil and the hearing aid has one receiver coil, loss of data (i.e. drop out) can occur if the transmitter and receiver antenna coils are placed unfavourably, in particular perpendicularly (or nearly perpendicularly) to each other.

Head movement and rotation along with variations in relative position of the two communicating devices can make it very difficult to guarantee a system that will work without any drop outs regardless of usage. When using streaming audio from one device to another, where a major part of the available bandwidth is used by the audio signal (so that no error correction is possible), it is particularly important to provide a low drop out rate. In such a substantially ‘real time’ transmission (where e.g. additionally a ‘streamed’ audio signal is intended to match a simultaneous real or displayed image), a good transmission quality is important.

The use of electrically stimulated induction coils for generating magnetic fields to communicate between a transmitting coil of a transmitting device and a receiving coil of a receiving device is typically limited to relatively short distances (e.g. less than a few meters) and relatively low frequencies (e.g. less than 100 MHz).

The longer the distance over which a signal is to be wirelessly transmitted, the larger is the necessary field density produced by the transmitting coil (at a given location, e.g. in an end cross section of the coil), i.e. the larger the necessary current of the electrical signal through the transmitting coil, i.e. the larger the necessary power (energy over time). For a portable device, power consumption (i.e. battery lifetime) is an important parameter.

The risk of drop outs can be lowered by increasing the magnetic field density (and thus power consumption of the transmitting device). This is, however, not attractive due to the resulting increase in power consumption.

WO 01/74020 A1 describes the use of a rotating magnetic field to enhance communication with RF burst-transmitting tags of an object location system (RFID). WO 98/52295 describes short-range wireless audio communications using induction, e.g. between a portable audio source and a pair of headphones.

### DISCLOSURE OF INVENTION

An object of the present invention is to provide an alternative scheme for improving the quality of inductive communication between two (e.g. portable) devices.

The basic idea is to arrange at least two induction coils at an angle to each other in a transmitting device and to apply electrical signals comprising carrier signals comprising a carrier frequency f_{c} to the at least two induction coils, the carrier signals of the two electrical signals being phase shifted relative to each other.

The size of the antenna coils, the excitation of the individual antenna coil, and the phase difference between the excitation signals of each antenna coil can be varied to create different ‘polarizations’ of the magnetic field (e.g. elliptical (including circular)).

Objects of the invention are achieved by the invention described in the accompanying claims and as described in the following.

### A Communications Device:

In a first aspect, an object of the invention is achieved by a communications device for wireless communication with another device, the communications device comprising first and second induction coils for providing an inductive coupling to the other device by generating first and second magnetic fields in response to first and second electrical signals, the first and second induction coils defining respective first and second longitudinal axes, the first and second induction coils being located in the communications device so that their respective longitudinal axes are non-co-parallel, and the first and second electrical signals are adapted to be time varying electrical signals V₁(t), V₂(t), each comprising a carrier signal V_{1c}(t), V_{2c}(t), respectively, and a modulating signal, where V_{2c}(t)=K·V_{1c}(t+Δt₀), V being a voltage or current, K a constant, t being time, and Δt₀ a constant.

In a second aspect, an object of the invention is achieved by a communications device for wireless communication with another device, the communications device comprising first and second induction coils for providing an inductive coupling to the other device by generating first and second magnetic fields in response to first and second electrical signals, the first and second induction coils being located in the communications device and the first and second electrical signals adapted in such a way that a resulting rotating magnetic field is provided by the coils.

In a third aspect, an object of the invention is achieved by a communications device for wireless communication with another device, the communications device comprising first and second induction coils for providing an inductive coupling to the other device by generating first and second magnetic fields in response to first and second electrical signals each comprising a common carrier signal comprising a carrier frequency f_{c}, the first and second induction coils being located in the communications device and the first and second electrical signals adapted so that the magnetic field vector of the resulting magnetic field rotates in space with a rotation frequency equal to the carrier frequency f_{c}.

An advantage thereof is that a reduced drop out is achieved. An appropriate (low) drop out level is e.g. important, if the transmitted data contain an audio signal, e.g. a continuous (streaming) audio signal. A relatively higher drop out level can be accepted, if the transmitted data are control signals e.g. from a remote control device (where time delay can be accepted). In an embodiment, an increased signal quality is achieved. In an embodiment, the power consumption of the electrical signals exciting the first and second induction coils is smaller than or equal to the power consumption of a corresponding device comprising only one exciting coil (at a comparable or better signal quality).

In the present context, the term ‘a communications device for wireless communication with another device’ is taken to mean that the communications device is adapted to at least transmitting an electrical signal wirelessly to another device. It may further include that the communications device is adapted for receiving an electrical signal wirelessly transmitted from the other device (and/or from a third device).

In the present context, the terms ‘antenna coil’ and ‘induction coil’ are used interchangeably to denote an arrangement of electrically conducting wire(s) in which a time varying magnetic field can be generated by a time varying electric current through the wires (and wherein, vice-versa, a time varying electric current can be induced in the wire(s) by a time varying magnetic field). In an embodiment, an arrangement of wire(s) comprises at least one turn, typically a number of turns of a wire, e.g. wound around a central former. The central former can be of a circular cross section, but other forms, such as polygonal, e.g. rectangular or triangular, can be used.

In a particular embodiment, the first and second induction coils are located in the communications device so that the first and second longitudinal axes are substantially perpendicular to each other.

In a particular embodiment, the first and second electrical signals are adapted to be time varying electrical signals V₁(t), V₂(t), each comprising a carrier signal V_{1c}(t), V_{2c}(t), respectively, and a modulating signal, where V_{2c}(t)=K_{c}·V_{1c}(t+Δt₀), V_{ic} being a voltage over, or a current through a respective coil i, i=1, 2, K_{c} a constant, t being time, and Δt₀ a constant.

In a particular embodiment, the first and second electrical signals are substantially identical apart from their phase Δt₀ (such as the phase of the carrier signal).

In an embodiment, the carrier signal V_{ic}(t) (i=1, 2) of the electrical signals of the first and second induction coils is a signal that varies periodically in time with a predefined time cycle T_{c}, so that V_{ic}(t)=V_{ic}(t−T_{c}) and Tc=1/f_{c}, where f_{c} is the carrier frequency. In general, the periodic carrier signal can be of any nature. In an embodiment, the electrical carrier signal can have a substantially saw tooth, rectangular, or sinusoidal form.

In a particular embodiment, the first and second electrical signals V₁(t), V₂(t) comprise a carrier with a carrier frequency f_{c} and wherein V₁(t) can be represented as V_{1c,0}·cos(2·π·f_{c}·t), where V_{1c,0} is a constant and V₂(t) can be represented as V_{2c,0}·cos(2·π·f_{c}·t+Δφ), where V_{2,0} and Δφ are constants. In an embodiment, V_{1c,0} is substantially equal to V_{2c,0} (V_{1c,0}˜V_{2c,0}).

In an embodiment, the phase constant Δφ and the angle between the first and second longitudinal axes of the first and second induction coils are adapted to optimize the pattern of the magnetic field vector resulting from the two excited coils with a view to the typical relative orientation of the communications device and the other device during use. In a particular embodiment, the phase constant Δφ is substantially an integer multiple of π/2 (i.e. Δφ=n·π/2, where n is an integer different from 0). By using two orthogonal antenna coils and exciting them 90 degrees out of phase, a resulting rotating magnetic field can be generated. This means that the receiver antenna coil can be placed arbitrarily in the plane of the rotating field as long as the receiver coil is not oriented perpendicular to that plane. Thereby an acceptable, continuous signal can be received with a lower risk of being interrupted.

In an embodiment, the modulating signals V₁ₘ(t), V₂ₘ(t) comprise the information to be transmitted from the communications device to the other device. In an embodiment, V₁ₘ(t)=Kₘ·V₂ₘ(t), where Kₘ is a constant. In an embodiment, Kₘ˜K_{c}. In an embodiment, Kₘ˜1. In an embodiment, the modulating signal is an audio signal, such as a continuous (streaming, digital, e.g. encoded) audio signal. In the present context, the term ‘a continuous or streaming audio signal’ is to be understood in the sense that it is continuously generated by a source, e.g. having a duration of more than 10 seconds, such as typically more than one minute.

The modulation can be of any appropriate nature, e.g. amplitude modulation or frequency modulation or a logic combination of carrier and modulating signal.

In general the modulating signal can be of any nature, which is appropriate for wireless transmission and extraction at the receiving device. In an embodiment, the modulating signal is encoded, e.g. to provide a signal that is adapted for relatively easy extraction at the receiver of the other device. In an embodiment, the modulating signal is a digital signal. In an embodiment, the modulating signal is encoded according to a standardized protocol, e.g. CMI, NRZ, RZ, 8b10b, Manchester, etc. In an embodiment, an error detecting code scheme is used. In an embodiment, en error correcting code scheme is used.

In a particular embodiment, the carrier is amplitude modulated. In a particular embodiment, the modulating signal is a digital signal. In a particular embodiment, the carrier of the first and/or second electrical signal is modulated by an On-Off keying signal, whose amplitude is substantially equal to a first constant (e.g. zero) for a predefined zero-time T₀ and substantially equal to a second constant different from the first constant for a predefined one-time T₁. This provides a modulation that is easy to implement and extract. In an embodiment, one of the first or second constants is equal to zero.

In a particular embodiment, the predefined zero-time is substantially equal to the predefined one-time (T₀˜T₁).

In a particular embodiment, each of the predefined zero-time and the predefined one-time are substantially equal to a predefined number of time periods T_{c} of the carrier (T₀, T₁˜nₚ·T_{c}). In an embodiment, the number nₚ of time periods T_{c} is larger than or equal to 8, such as larger than or equal to 16, such as larger than or equal to 32.

In a particular embodiment, the communications device is adapted to provide that the modulation of the On-Off keying signal is substantially equal in time for the first and second electrical signals, so that the phase of the On-Off keying signal is substantially equal in V₁ and V₂. Thereby the carrier signals are out-of-phase but the data keyed on the carrier using On-Off keying (the modulating signals) are in-phase.

In general, both or all coils may comprise a core for amplifying the magnetic flux density of the coil. In a particular embodiment, at least one of the first and second induction coils comprise(s) a core of a magnetically soft magnetic material, such as a core comprising iron and/or nickel, e.g. an iron alloy or a ceramic material, such as a ferrite material. Alternatively, at least one of the first and second induction coils comprise(s) an air-filled core (i.e. a core without any flux amplifying material). The choice of core material may be decided according to the needed flux density (transmission distance), cost issues, power consumption restraints, etc.

In a particular embodiment, the inductive coupling between the communications device and the other device is optimized to a predefined frequency range. In a particular embodiment, the communications device comprises a tuning circuit for optimizing the frequency range. In a particular embodiment, at least one of the first and second induction coils, preferably both coils, is/are adapted to provide a specific preferred frequency range for the inductive communication by adapting at least one of the cross-sectional area, the number of turns, the choice of core material in the coil, the values of a capacitor and/or a resistor of a resonance circuit formed by the coil, the capacitor and/or the resistor. In a particular embodiment, the communication between the communications device and the other device is in the MHz-range, e.g. in the range between 1 MHz and 30 MHz or between 10 MHz and 100 MHz).

In a particular embodiment, the communications device is adapted to be body-worn. In a particular embodiment, the communications device is powered by a battery included in the device. In a particular embodiment, the communications device is an audio transmission device adapted for wirelessly transmitting a continuous (typically digital, e.g. encoded provide sufficient bandwidth) audio signal (streaming audio) to a receiving audio device, such as a listening device, such as a head-worn audio listening device, e.g. a head set, a pair of headphones or a hearing aid.

### A System:

In a further aspect, a communications system comprising a communications device as described above, in the detailed description and in the claims and another device adapted for wirelessly communicating with the communications device is provided. In a particular embodiment, the other device is body-worn, e.g. head-worn. In a particular embodiment, the communications device is body-worn.

In an embodiment, the first and second coils of the communications device are adapted to wirelessly transmit an electrical signal to another device (which is adapted to receive the signal).

The system has the same advantages as indicated for the device. A further advantage of the invention in a system comprising a body-worn, relatively larger communications device according to the invention (the communications device) and a body-worn relatively smaller device, such as a hearing aid, (the other device) is that by locating the improvement (an extra transmitter coil and electronic circuitry for its excitation) in the relatively larger communications device, scarce volume (and power) can be saved in the relatively smaller device. The other device can in principle contain more than one (receiving) coil (preferably arranged perpendicular to each other) to improve the quality of reception. In a particular embodiment, however, the other device contains only one induction coil adapted for wirelessly receiving a signal transmitted from the first and second induction coils of the communications device. This has the advantage of saving space and possibly energy in the other device.

In a particular embodiment, the other device is adapted for being fully or partially implanted in the human body.

In a particular embodiment, the other device is a hearing aid or a head set or a pair of head phones.

In a particular embodiment, the communications device is powered by a battery included in the device. In a particular embodiment, the communications device is an audio transmission device adapted for wirelessly transmitting a continuous audio signal (streaming audio, e.g. a digital (e.g. encoded) signal) to the other device. In a particular embodiment, the other is a receiving audio device, such as a listening device, such as a head-worn audio listening device, e.g. a head set, a pair of headphones or a hearing aid.

### A Method:

In a further aspect, a method of inductive transmission from a communications device to another device is provided, the method comprising
Providing a communications device with first and second induction coils;
Providing the other device with at least one induction coil;
Applying first and second electrical signals to the first and second induction coils, respectively;
Providing that each of the first and second electrical signals comprise a carrier signal comprising a carrier frequency f_{c}, whereby first and second magnetic fields are generated by the first and second induction coils;
Providing that the first and second induction coils of the communications device and the at least one induction coil of the other device are spatially oriented and located relative to each other to provide an inductive coupling between them when said first and second electrical signals are applied; and
Providing that the first and second electrical signals are adapted so that the magnetic field vector of the resulting magnetic field rotates in space.

The method has the same advantages as indicated for the device.

In an embodiment, the method further comprises providing that the carrier signal of the first and second induction coils are phase shifted, preferably by a multiple of π/2, relative to each other. Thereby it is achieved that the magnetic field vector of the resulting magnetic field rotates in space.

In an embodiment, the method further comprises applying a modulating signal to the carrier signal by frequency modulation or amplitude modulation.

In an embodiment, the method further comprises providing that the carrier of the first electrical signal is modulated by an On-Off keying signal whose amplitude is substantially equal to a first constant (e.g. zero) for a predefined zero-time T₀ and substantially equal to a second constant different from the first constant for a predefined one-time T₁.

In an embodiment, the communications device and the other device are arranged to be located on the body of a human being, e.g. within 2 m from each other, such as less than 1.5 m from each other, such as less than 1 m from each other, such as less than 0.75 m from each other. In an embodiment, the communications device is arranged to be located near or on the upper part of a person (e.g. in the breast region, e.g. hanging around the neck) and the other device is a head-worn device, e.g. a hearing aid located behind the ear or in the ear canal or implanted in the body. In an embodiment, the arrangement of the first and second induction coils of the communications device, the at least one induction coil of the other device (including their mutual orientation and distance) and the first and second electrical signals exciting the first and second induction coils are adapted to provide an optimized coupling between the coils of the two devices to provide a minimum drop out in the transmission of an information signal (modulating signal) from the communications device to the other device. In a particular embodiment, the modulating signal is an audio signal, such as a continuous audio signal (streaming audio, e.g. a digital, e.g. encoded signal).

It is intended that the features of the device and the system as described above, in the detailed description and in the claims can be combined with the method as described above, where appropriate, and vice versa.

Further objects of the invention are achieved by the embodiments defined in the dependent claims and in the detailed description of the invention.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements maybe present. Furthermore, “connected” or “coupled” as used herein may include wirelessly connected or coupled. As used herein, the term “and/or” includes any and all combinations of one or more of the associated listed items.

### BRIEF DESCRIPTION OF DRAWINGS

The invention will be explained more fully below in connection with a preferred embodiment and with reference to the drawings in which:

FIG. 1 shows a communications system comprising a communications device and another device, the devices being adapted for inductively communicating with each other,

FIG. 2 is an illustration of various states of a rotating magnetic field around a communications device and another device as generated by an assembly of non-co-parallel coils excited by phase shifted signals,

FIG. 3 shows an (idealized) example of carrier, modulating and modulated signals for exciting first and second coils of the communications device,

FIG. 4 shows an (idealized) example of modulated and modulating (extracted) signals received by the other device, and

FIG. 5 shows an example of the generation of a phase shifted carrier signal.

The figures are schematic and simplified for clarity, and they just show details which are essential to the understanding of the invention, while other details are left out.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### MODE(S) FOR CARRYING OUT THE INVENTION

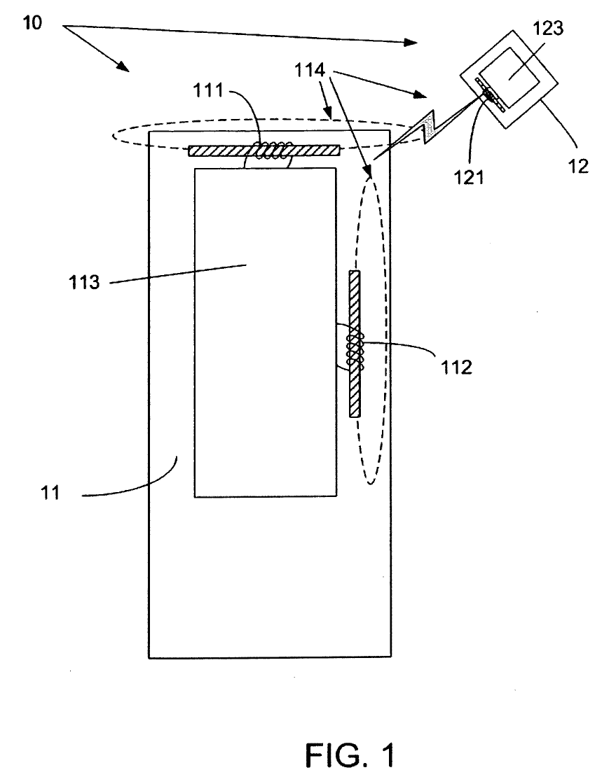

FIG. 1 shows a communications system comprising a communications device and another device, the devices being adapted for inductively communicating with each other. Both devices are adapted to be body-worn and each comprises a battery for powering the device in question.

The wireless communication of sound picked up by one device to another another device for being presented there typically comprises the following string of processes: Sound->acoustic to electric conversion->sampling->analogue to digital conversion->encoding/data compression->transmission->reception->decoding->digital to analogue conversion->filtering->electric to acoustic conversion->sound. FIG. 1 relates to the transmission->reception processes.

In the embodiment of FIG. 1, two identical coils 111, 112, each comprising a ferrite core rod are used in the communications device 11 (e.g. an audio selection device) to produce a magnetic field. The induction coils are preferably placed orthogonally to each other and so that their cross-coupling is minimized (e.g. by proper spatial orientation and separation of the two coils). Also, the coils 111, 112 are placed in consideration of the location and orientation of the two devices 11, 12 relative to each other when in use, including the position of the coil 121 of the other device 12 (e.g. a hearing aid) during use (e.g. when worn in or behind an ear and considering the displacement/rotation of the hearing aid with normal movement/rotation of the head).

In the present embodiment, the targeted carrier frequency f_{c} is 3.84 MHz. An inductance for the coils of approximately ˜19 pH is aimed at, which has been accomplished using N_{c}˜32 turns on a ferrite core (e.g. from Fair-Rite Products Corp., Wallkill, NY, USA) of approximately 25 mm in length with a diameter of 3 mm. A tuning circuit comprising the coil, a trimming capacitor (e.g. TZC3P300A110B00 from Murata, Kyoto, Japan) and two ceramic capacitors (180 pF) and a series resistor of 12Ω is used. Tuning of the antenna coil to a particular frequency is e.g. done by adjusting the position of the turns on the ferrite core, and/or by using the trimming capacitor.

In the present embodiment, the two coils 111, 112 of the communications device 11 are excited by electronic circuit 113. Preferably the exciting electrical signals each comprise a carrier signal with a carrier frequency f_{c}, the two carrier signals (V_{1c}, V_{2c}) being out of phase (preferably 90 degrees), e.g. implemented by means of two transmitter circuits (e.g. H-bridge drivers). The other device 12 comprises an induction coil 121 adapted to inductively communicate with coils 111, 112 via the magnetic field 114 (i.e. at least to be able to receive a transmitted signal from communications device 11). The other device 12 further comprises an electronic circuit 123 connected to the coil 121 for receiving the electrical signal transmitted from the communications device (and induced in the coil 121) and for extracting the modulated signal for use in the other device 12. The communications device 11 is e.g. an audio transmission device, such as a mobile telephone or a music player or an audio selection device for selecting an audio signal among a multitude of audio signals and for wirelessly transmitting it to another device. The other device 12 is e.g. a listening device, such as a hearing instrument.

In an embodiment, the first and second electrical signals are adapted to be time varying electrical signals V₁(t), V₂(t), each comprising a carrier signal V_{1c}(t), V_{2c}(t), respectively, and a modulating signal V₁ₘ(t), V₂ₘ(t), where V_{2c}(t)=K_{c}·V_{1c}(t+Δt₀), V being a voltage or current, K_{c} a constant, t being time, and Δt₀ a constant. In an embodiment, the carrier signal comprises a carrier frequency f_{c}. V_{1c}(t) can e.g. be represented as V_{1c,0}·cos(2·π·f_{c}·t), where V_{1c,0} is a constant and V_{2c}(t) can be represented as V_{2c,0}·cos(2·π·f_{c}·t+Δφ), where V_{2c,0} and Δφ are constants. Preferably, Δφ=n·π/2, where n is an integer different from 0. In an embodiment, V_{1c,0}˜V_{2c,0}. Alternatively, the carrier signal can have other waveforms appropriate for the particular application, e.g. square wave or triangular.

In an embodiment, the modulating signals V₁ₘ(t), V₂ₘ(t) comprise the information to be transmitted from the communications device to the other device. In an embodiment, V₁ₘ(t)=Kₘ·V₂ₘ(t), where Kₘ is a constant. In an embodiment, the modulating signal is a continuous (e.g. digital) audio signal.

In an embodiment, the electronic circuit 113 of the communications device 11 is adapted to provide that the carrier signal is 90 degrees out of phase between the first and second induction coil (i.e. V_{1c}(t)=V_{1c,0}·cos(2·π·f_{c}·t), V_{2c}(t)=V_{2c,0}·sin(2·π·f_{c}·t)), whereas the modulating signal (i.e. the data keyed on the carrier) is in phase (i.e. V₁ₘ(t)=Kₘ·V₂ₘ(t)) for the two coils. Alternatively, the modulating signals V₁ₘ(t), V₂ₘ(t) can likewise be phase shifted relative to each other, with another amount or e.g. with substantially the same amount as between the carriers.

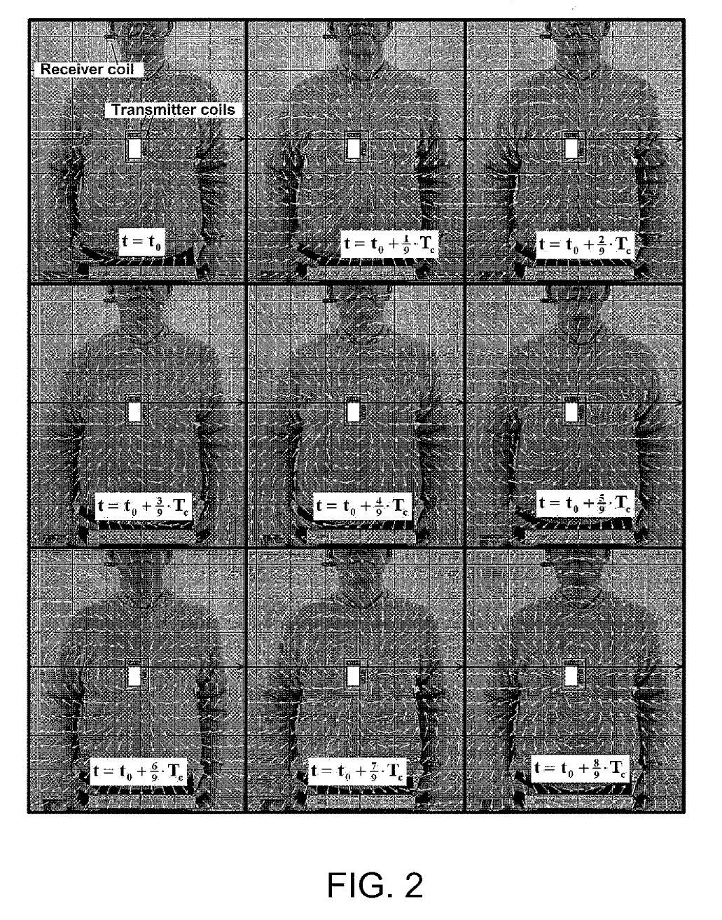

FIG. 2 shows various states of a rotating magnetic field around a communications device and another device at various locations around the devices as generated by an assembly of non-co-parallel coils excited by phase shifted signals. FIG. 2 illustrates the time variation of the directions of the magnetic field from two orthogonally arranged transmitter coils of a body-worn communications device (cf. 11 in FIG. 1) when excited by a carrier signal that is 90° out of phase between the two transmitter coils (cf. induction coils 111, 112 in FIG. 1) at 9 different points in time of a time cycle of the carrier starting at time t₀ (at each location). The corresponding relative time t=t₀+(n/9)·T_{c} (n=0, 1, . . . , 8) of a particular pattern is indicated at each diagram. By generating a rotating magnetic field at the location of the other device, here e.g. a hearing aid, the magnetic field (during the course of any given cycle of the carrier frequency) will advantageously have a component along the axis of the receiver coil (cf. induction coil 121 in FIG. 1) at its location in the hearing aid (12 in FIG. 1) when worn by a user (as long as the induction coil of the other device is NOT perpendicular to the plane spanned by the two induction coils of the communications device). This is e.g. illustrated by following the direction of an arrow just to the left of the receiver coil in FIG. 2 when moving from the diagram corresponding to t=t₀ towards the diagram corresponding to t=t₀+(8/9)·T_{c}. Such arrow will perform a full rotation in one cycle T_{c} of the carrier frequency f_{c}. The amplitude of the magnetic field at each point in time and at each location will depend on the relative amplitude of the electrical signals (V_{1c,0}, V_{2c,0}) of the two transmitter coils, the carrier frequency, and of the distance to the transmitter coils of the communications device. If V_{1c,0}=V_{2c,0}, the magnetic field at a given point will be of substantially equal amplitude in all directions of the plane (the amplitude decreasing with distance from the transmitter coils); if not, it will be of different amplitude depending on the direction.

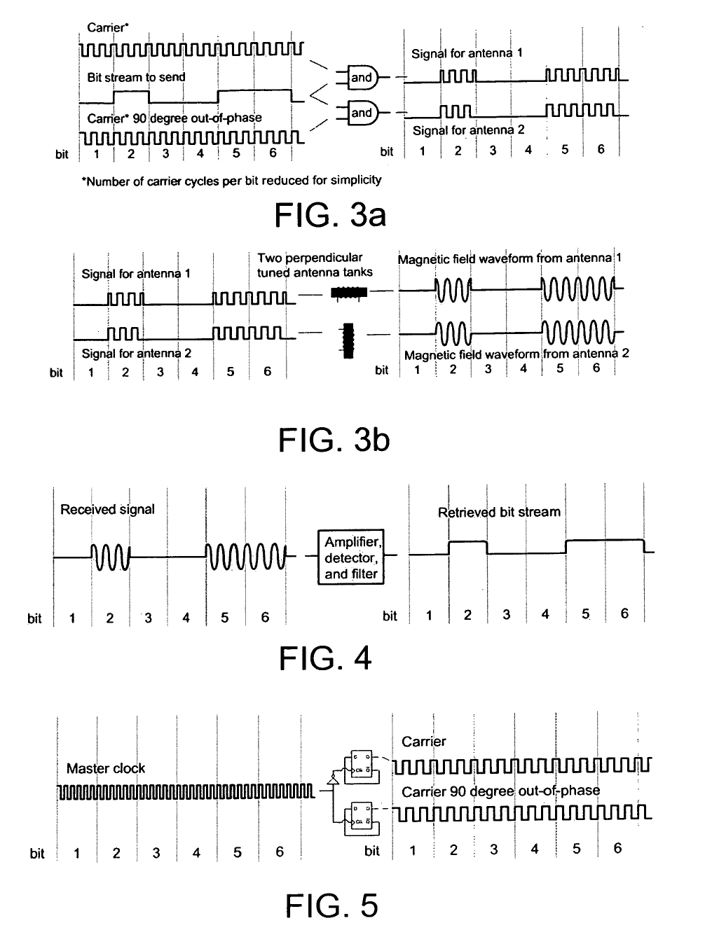

In general, an information carrying signal can be modulated with a carrier signal in any appropriate way, here chosen with a view to the particular application considering design parameters such as appropriate frequency range, power consumption, transmission range (distance), information content (bandwidth of the information), etc. FIG. 3 shows an (idealized) example of carrier and modulating and modulated signals for exciting first and second coils of the communications device. FIG. 3a schematically shows the generation of the electrical signals for the two transmitter coils of a communications device according to an embodiment of the invention. The left part shows carrier signals V_{1c} (top, carrier) and V_{2c} (bottom, carrier 90 degree out-of-phase), here shown as square wave signals, mutually phase shifted by 90°. Between the carrier signals an example of a modulating signal V₁ₘ (V₂ₘ) (Bit stream to send) is shown. As seen from the bit numbering below the bottom carrier signal in FIG. 3a, one bit of the modulating signal contains three cycles T_{c} of the carrier signal. As indicated, this is a relatively low number, which may be adapted according to design criteria for the necessary bit rate, transmission security, etc. The middle part of FIG. 3a schematically illustrates the digital combination of the top and bottom carrier signals with the modulating signal via respective AND gates/functions to provide the resulting electrical signals V₁ (signal for antenna 1), V₂ (signal for antenna 2) for exciting the respective transmitter coils. These exciting signals are indicated in the right part of FIG. 3a. In the embodiment of FIG. 3, the exciting signals for the transmitter coils are thus given by Vᵢ=V_{ic}*Vₘ (where i=1, 2, Vₘ=V₁ₘ=V₂ₘ and where ‘*’ represents a logic AND function). FIG. 3b schematically illustrates the generation of the magnetic field waveforms (indicated in the right part of FIG. 3b) from the exciting electrical signals (indicated in the left part of FIG. 3b). In the middle part of FIG. 3b, the corresponding orthogonally arranged transmission antenna coils are schematically indicated. The tuned antenna tanks (induction coils) effectively band pass filter the square waves of the electric carrier signal and remove the low and high frequency contents (including e.g. the dc-contents) to provide a smoothly (substantially sinusoidally) varying magnetic field.

FIG. 4 shows an (idealized) example of modulated and modulating (extracted) signals received by the other device. FIG. 4 schematically shows the extraction of the modulating signal Vₘ (to be used by the other device) from the electric signal induced in the receiver coil by the magnetic field generated by the two transmitter coils of the communications device (cf. FIG. 3). The rotating magnetic field generated by the vector combination of the magnetic fields from the two transmitting coils of FIG. 3 (and as e.g. illustrated in FIG. 2) is received in a receiver coil of the other device (e.g. a hearing aid), when properly located in its vicinity. The magnetic field waveform (and/or induced electrical signal waveform) is schematically shown in the left part of FIG. 4 (received signal). The Amplifier, detector and filter block in the middle of FIG. 4 is adapted to extract the modulating signal Vₘ (retrieved bit stream) using extraction techniques adapted to the scheme used for encoding the modulating signal. The amplifier could be a low-noise-amplifier (LNA) and/or an automatic-gain-control (AGC) amplifier to compensate for a large dynamic range in the received signal. The detector could be a half-wave rectifier (e.g. diode clipper). The filter could be a low pass filter to remove the un-wanted frequency contents left or generated by the detector without removing the desired signal (i.e. the bit stream).

FIG. 5 shows an example of the generation of a phase shifted carrier signal. An (ideally) square waved master clock (e.g., being twice the carrier frequency, f_{clock}=2·f_{c}) is used as a basis for the carrier signals for exciting the induction coils. This clock signal, in its respective true and inverted form, is fed to the clock inputs (CK) of two D-flip-flops, both having their inverted outputs (Q) connected to their data inputs (D). The true outputs (Q) of the two D-flip-flops represent, respectively, the Carrier and the Carrier 90 degree out-of-phase.

The invention is defined by the features of the independent claim(s). Preferred embodiments are defined in the dependent claims. Any reference numerals in the claims are intended to be non-limiting for their scope.

Some preferred embodiments have been shown in the foregoing, but it should be stressed that the invention is not limited to these, but may be embodied in other ways within the subject-matter defined in the following claims.

### REFERENCES

EP 1 460 769 A1 (PHONAK) 22 Sep. 2004
WO 01/74020 A1 (WHERENET CORP) 4 Oct. 2001
WO 98/52295 A1 (AURA COMMUNICATIONS) 19 Oct. 1998

1. A communications device for wireless communication with another device, the communications device comprising first and second induction coils for providing an inductive coupling to the other device by generating first and second magnetic fields in response to first and second electrical signals, the first and second induction coils defining respective first and second longitudinal axes, the first and second induction coils being located in the communications device so that their respective longitudinal axes are non-co-parallel, and the first and second electrical signals are adapted to be time varying electrical signals V₁(t), V₂(t), each comprising a carrier signal V_{1c}(t), V_{2c}(t), respectively, and a modulating signal, where V_{2c}(t)=K·V_{1c}(t+Δt₀), V being a voltage or current, K a constant, t being time, and Δt₀ a constant.

2. A communications device according to claim 1 wherein first and second induction coils are located in the communications device so that the first and second longitudinal axes are substantially perpendicular to each other.

3. A communications device according to claim 1 wherein the first and second electrical signals are adapted to be time varying electrical signals V₁(t), V₂(t), each comprising a carrier signal V_{1c}(t), V_{2c}(t), respectively, and a modulating signal, where V_{2c}(t)=K·V_{1c}(t+Δt₀), V_{ic} being a voltage over a or a current through respective coil i, i=1, 2, K a constant, t being time, and Δt₀ a constant.

4. A communications device according to claim 1 wherein the first and second electrical signals are substantially identical apart from their phase Δt₀.

5. A communications device according to claim 1 wherein the first and second electrical signals V₁(t), V₂(t) comprise a carrier with a carrier frequency f_{c} and wherein V₁(t) can be represented as V_{1c,0}·cos(2·π·f_{c}·t), where V_{1c,0} is a constant and V₂(t) can be represented as V_{2c,0}·cos(2·π·f_{c}·t+Δφ), where V_{2c,0} and Δφ are constants.

6. A communications device according to claim 5 wherein the phase constant Δφ is substantially an integer multiple of π/2.

7. A communications device according to claim 1 adapted so that the carrier is modulated by a modulating signal by frequency or amplitude modulation.

8. A communications device according to claim 1 wherein the carrier of the first electrical signal is modulated by an On-Off keying signal whose amplitude is substantially equal to zero for a predefined zero-time T₀ and substantially equal to a constant different from zero for a predefined one-time T₁.

9. A communications device according to claim 8 wherein the predefined zero-time is substantially equal to the predefined one-time.

10. A communications device according to claim 8 wherein each of the predefined zero-time and the predefined one-time are substantially equal to a predefined number of time periods T_{c} of the carrier.

11. A communications device according to claim 8 wherein the communications device is adapted to provide that the modulation of the On-Off keying signal is substantially equal in time for the first and second electrical signals, so that the phase of the On-Off keying signal is substantially equal in V₁ and V₂.

12. A communications device according to claim 1 wherein at least one of the first and second induction coils comprise(s) a core of a magnetically soft magnetic material, such as a core comprising iron and/or nickel, e.g. an iron alloy or a ceramic material, such as a ferrite material.

13. A communications device according to claim 1 wherein the inductive coupling between the communications device and the other device is optimized to a predefined frequency range.

14. A communications device according to claim 13 wherein—at least for one of the first and second induction coils, preferably for both coils—the cross-sectional area, the number of turns, the values of a capacitor and/or a resistor of a resonance circuit formed by the coil, the capacitor and/or the resistor to provide a specific preferred frequency range for the inductive communication are adapted.

15. A communications device according to claim 1 wherein the communication between the communications device and the other device is in the MHz-range, e.g. in the range between 1 MHz and 30 MHz or between 10 MHz and 100 MHz.

16. A communications device according to claim 1 wherein the communications device is adapted to be body-worn.

17. A communications device for wireless communication with another device, the communications device comprising first and second induction coils for providing an inductive coupling to the other device by generating first and second magnetic fields in response to first and second electrical signals, the first and second induction coils being located in the communications device and the first and second electrical signals adapted in such a way that a resulting rotating magnetic field is provided by the coils.

18. A communications device for wireless communication with another device, the communications device comprising first and second induction coils for providing an inductive coupling to the other device by generating first and second magnetic fields in response to first and second electrical signals each comprising a common carrier signal comprising a carrier frequency f_{c}, the first and second induction coils being located in the communications device and the first and second electrical signals adapted so that the magnetic field vector of the resulting magnetic field rotates in space with a rotation frequency equal to the carrier frequency f_{c}.

19. A communications system comprising a communications device according to claim 1 and another device adapted for wirelessly communicating with the communications device.

20. A communications system according to claim 19 wherein the other device is adapted for being fully or partially implanted in the human body.

21. A communications system according to claim 19 or wherein the other device is a hearing aid or a head set or a pair of head phones.

22. A method of inductive transmission from a communications device to another device comprising
Providing a communications device with first and second induction coils;
Providing the other device with at least one induction coil;
Applying first and second electrical signals to the first and second induction coils, respectively;
Providing that each of the first and second electrical signals comprise a carrier signal comprising a carrier frequency f_{c}, whereby first and second magnetic fields are generated by the first and second induction coils;
Providing that the first and second induction coils of the communications device and the at least one induction coil of the other device are spatially oriented and located relative to each other to provide an inductive coupling between them when said first and second electrical signals are applied; and
Providing that the first and second electrical signals are adapted so that the magnetic field vector of the resulting magnetic field rotates in space.

23. A method according to claim 22 further comprising providing that the carrier signal of the first and second induction coils are phase shifted, preferably by a multiple of π/2, relative to each other.

24. A method according to claim 22 further comprising applying a modulating signal to the carrier signal by frequency modulation or amplitude modulation.

25. A method according to claim 24 further comprising providing that the carrier of the first electrical signal is modulated by an On-Off keying signal whose amplitude is substantially equal to zero for a predefined zero-time T₀ and substantially equal to a constant different from zero for a predefined one-time T₁.

26. A method according to claim 24 wherein the modulating signal is an audio signal, e.g. a continuous audio signal.
